(19) United States
(12) Patent Application Publication
(10) Pub. No.: US 2013/0103472 A1
(43) Pub. Date: Apr. 25, 2013

(54) AFFILIATE OFFER REDEMPTION METHOD AND SYSTEM

(71) Applicant: Linkable Networks, Boston, MA (US)

(72) Inventors: Thomas Burgess, Portsmouth, RI (US); Francis Correra, Andover, MA (US)

(73) Assignee: LINKABLE NETWORKS, Boston, MA (US)

(21) Appl. No.: 13/660,994

(22) Filed: Oct. 25, 2012

Related U.S. Application Data
(60) Provisional application No. 61/551,206, filed on Oct. 25, 2011.

(51) Int. Cl. G06Q 30/02

(52) U.S. Cl. 705/14.17

(57) ABSTRACT

An offer processing system and method allows offers that are presented to a consumer by an affiliate to be accepted and thereafter, the offer including its conditions and an affiliate identifier are linked to a consumer payment account. Once linked, the accepted offer can be redeemed either online or offline at a physical location with payment to the affiliate being made through the offer processing system regardless of the manner of redemption, provided other conditions of the offer are fulfilled by the consumer. The offer processing system may comprise a server computer system, having a linked offer gateway, which performs all, or some selected combination of the functions for accepting and redeeming the affiliate offer.

### CROSS-REFERENCE TO RELATED APPLICATIONS

This application claims the benefit of priority to U.S. Provisional Patent Application No. 61/551,206, filed Oct. 25, 2012 and entitled “Affiliate Offer Redemption Method and System”, the entire contents of the application being incorporated herein by reference in its entirety.

### TECHNICAL FIELD

The present application is generally directed to a method and system for presenting affiliate offers to consumers online and processing offer redemptions. The system includes a linked offer gateway or offer processing system that links affiliate offers from advertisers directly to existing payment accounts of consumers and enables redemption of the affiliate offer at both online and offline or “brick and mortar” locations.

### BACKGROUND

Affiliate marketing is generally used to describe a method whereby affiliates promote products, subscriptions, services, and the like, of an on-line merchant and where the affiliate is rewarded for every visitor, subscriber and/or customer provided through their efforts. Compensation may be made based on a certain value for each visit (Pay-per-click), registrant (Pay-per-lead), or a commission for each customer or sale (Pay-per-Sale). The industry generally has four core players: the merchant (also known as ‘retailer’ or ‘brand’), the network (that contains offers for the affiliate to choose from and also takes care of the payments to the affiliate), the publisher (also known as ‘the affiliate’), and the consumer.

To become an affiliate, an individual will often join a merchant or small business owner's affiliate program for free, or an affiliate network, and will receive a special hyperlink with the affiliate's identifier, or ID. When a consumer clicks on the affiliate's link they are taken to the merchant's website. If the consumer buys from the merchant, the link is tracked and a commission for the sale is made to the affiliate. No payment is due to the affiliate until results are realized. Affiliate marketing has grown since its inception and continues to be a viable marketing tool for on-line merchants.

### SUMMARY

While generally a win-win for both the affiliate and the on-line merchant, many merchants also have a physical location, i.e. brick and mortar stores, in addition to an online site and want to drive consumer traffic to these stores as well. Some consumers may also prefer to purchase products from brick and mortar stores and not online as they can see and try on the products at the physical store. For affiliate marketers, the click-through links that are provided online traditionally do not transfer to purchases made by a consumer at a physical location. The invention disclosed herein provides a method and system for a consumer to redeem an offer from an affiliate at a physical location or online, depending upon the conditions of the offer, in a seamless, automatic fashion without addition steps required by the consumer regardless of whether they redeem the offer online or in-person at a physical location.

The offer processing system and method described herein allows offers that are presented to a consumer by an affiliate to be accepted and thereafter, the offer including its conditions and an affiliate identifier are linked to a consumer payment account. Once linked, the accepted offer can be redeemed either online or offline at a physical location with payment to the affiliate being made through the offer processing system regardless of the manner of redemption, provided other conditions of the offer are fulfilled by the consumer. The offer processing system may comprise a server computer system, having a linked offer gateway, which performs all, or some selected combination of the following functions (i.e. steps), as desired:

Step 1: A consumer who has registered their payment account with the offer processing system, is presented with an affiliate offer in the form of an advertisement on any affiliate publisher website or in any display, destination, search, mobile, social or any other environment.

Step. 2: The consumer accepts the offer, for example by clicking on the link or scanning a display advertisement, in order to activate and link the affiliate offer (as described in step 3 below). Consumers can also accept offers in other manners, according to the available technology, as described in greater detail herein below.

Step 3: The link handler at the linked offer gateway, upon receiving the consumer's request, links the affiliate offer to the consumer's registered payment method. The linked offer gateway also links the Affiliate's ID (provided by the affiliate network) to the offer linked to the consumer's registered payment method.

Step 4: The linked offer gateway may then confirm the acceptance, for example by redirecting the consumer to the appropriate confirmation page, where the consumer is informed that the affiliate offer has been successfully linked to the consumer's payment account and affirms the associated terms and conditions.

Step 5: A link confirmation is optionally sent to the consumer's mobile or other electronic, telecommunication, or computing device.

Step 6: The consumer redeems the affiliate offer by making a purchase in accordance with the terms and conditions of the affiliate offer, either online or offline, at a physical location.

Step 7: The consumer's purchase transaction data travels along the financial rails to the card-issuing bank and is, in turn, shared with the linked offer gateway, typically on a daily basis (which has been authorized by the consumer during the initial credit/debit card registration process).

Step 8: Upon receiving the transaction data from the card-issuing bank, the linked offer gateway matches the consumer's transaction data to the linked offline affiliate offer terms and conditions.

Step 9: If the transaction data confirms that a qualified purchase has occurred (i.e., a “qualified transaction”), the linked offer gateway notifies the affiliate network that the affiliate offer has been redeemed and provides the data necessary to confirm that redemption in accordance with the affiliate terms and conditions has occurred. The affiliate ID linked to the offer is also provided to the affiliate network to identify the affiliate who is to be compensated for the transaction.

Step 10: A redemption confirmation is optionally sent to the consumer's mobile or other electronic, telecommunication, or computing device.

Step 11: The affiliate network confirms redemption with the advertiser/merchant in its customary manner.

Step 12: The advertiser/merchant compensates the affiliate network in accordance with the agreed terms (as between the advertiser and the affiliate network).

Step 13: The affiliate network transmits payment to the linked offer gateway in accordance with the agreed terms (as between the affiliate network and the linked offer gateway).

Step 14: The linked offer gateway transmits an offer settlement according to the terms of the offer, for example a certain amount of settlement funds back to the consumer's credit/debit card account. The linked offer gateway may also, at its discretion, settle back to the consumer's credit/debit card account in advance of receiving payment from the affiliate network.

Step 15: A settlement confirmation is optionally sent to the consumer's mobile or other electronic, telecommunication, or computing device.

The functions of the offer processing system, and other processes described herein, may be implemented in software, hardware, firmware, or any combination thereof. The processes are preferably implemented in one or more computer programs executing on a programmable computer including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network. In accordance with one or more embodiments described herein the software includes a plurality of instructions stored therein which, when executed by at least one processor, cause the at least one processor to execute the above-described steps, or combination of steps.

### BRIEF DESCRIPTION OF THE DRAWINGS

The foregoing and other objects, features and advantages will be apparent from the following description of at least one exemplary embodiment, as illustrated in the accompanying drawings in which like reference characters refer to the same or similar components throughout the different views. For purposes of clarity, not every component may be labeled in every figure. The figures are included to provide an illustration and a further understanding of the various aspects and embodiments, and are incorporated in and constitute part of the specification, but are not intended as a definition of the limits of any particular embodiment. The drawings are not necessarily to scale, emphasis instead being placed upon illustrating the principles disclosed herein.

FIG. 1 illustrates an exemplary redemption of a system for presenting, accepting, and linking to a consumer payment account an affiliate offer and offline redemption of the affiliate offer;

FIG. 2 illustrates schematically the method of accepting and linking an affiliate offer utilizing the system of FIG. 1;

FIG. 3 illustrates schematically the method of offer redemption of the affiliate offer utilizing the system of FIG. 1; and

FIG. 4 illustrates schematically the method of payment/settlement of the offer to the consumer payment account and affiliate utilizing the system of FIG. 1.

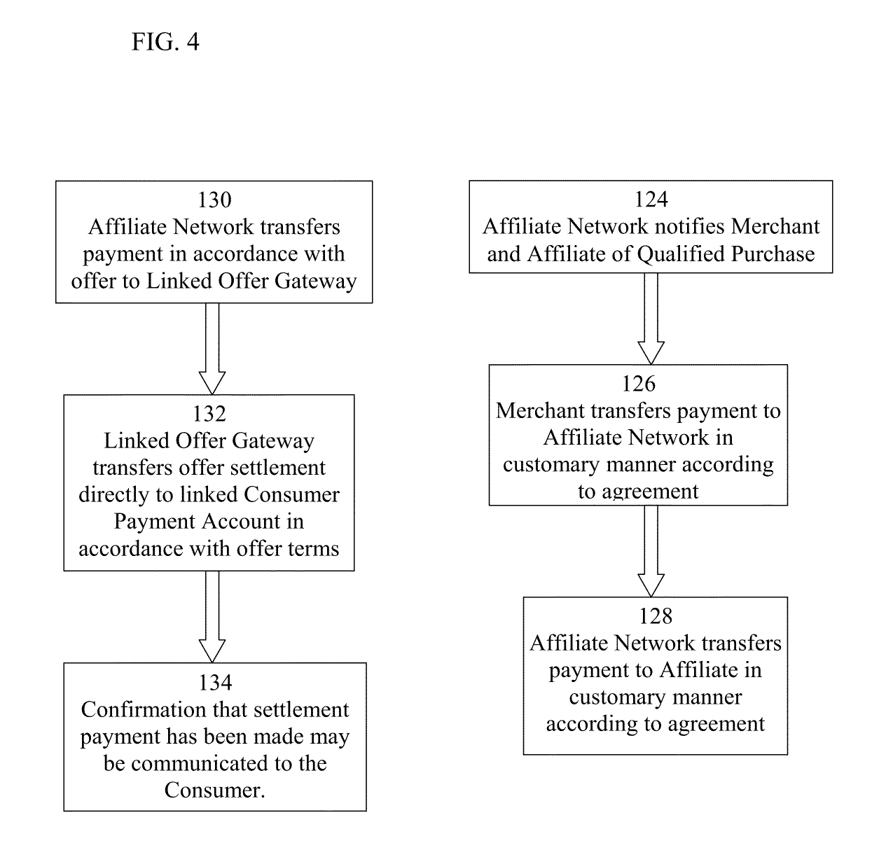

### DETAILED DESCRIPTION OF THE ILLUSTRATIVE EMBODIMENTS

The embodiments disclosed herein provide an offer processing system and method for storing, tracking, recording and redeeming offers that are made available to consumers through an affiliate. The offers and affiliate identifier are linked by the offer processing system to a registered consumer payment account. The offer may be redeemed online, or offline at a physical location, according to the terms of the offer. Upon redemption of the offer by the consumer using the registered consumer payment account, the offer processing system process the transaction and makes an offer settlement to the consumer and notifies the affiliate network for payment to the affiliate, without further action required by the consumer or affiliate.

As used herein, the term “offer” refers to an offer, incentive, inducement, rebate, or the like, presented to a consumer to encourage the consumer to purchase a product, service, membership and the like. Such incentives may include, but are not limited to, purchasing a particular product or service (or a collection of products or services) or for making a purchase from a particular retailer (or group of retailers) at a particular location (online and/or offline-at a physical, brick and mortar location). As also used herein, the term “affiliate offer” refers to an offer made available via an affiliate network and/or affiliate or other third party. In addition, the terms “offline location or store”, “physical location or store”, and “brick and mortar location or store” are used interchangeably to refer to any location or store other than on-line.

A variety of different types of consumer payment accounts or methods can be used in connection with the affiliate offer and redemption methods and systems described herein. In various examples described herein, the payment accounts of the consumers are described as being credit/debit accounts. This is by way of example only, and it should be understood that a variety of other types of consumer payment accounts and/or payment methods can be utilized including, but not limited to, gift cards, prepaid cards, PayPal and eWise accounts, mobile payment accounts, virtual money accounts, and rewards or points accounts. If a credit and/or debit card is utilized it can be either an open loop or closed loop card. In addition, instead of using a credit/debit card having account information presented in a magnetic stripe on the back of the card, payment and account details can be presented to merchants through a variety of other media, methods, and devices including, but not limited to, smart phones, retinal/finger scans, RFID tags, and any other technology implemented to process payments. Therefore, as used herein, the term “credit/debit card” is not intended to be limiting and includes any payment card, method, device, account or technology which processes payments and the form of payment method or account.

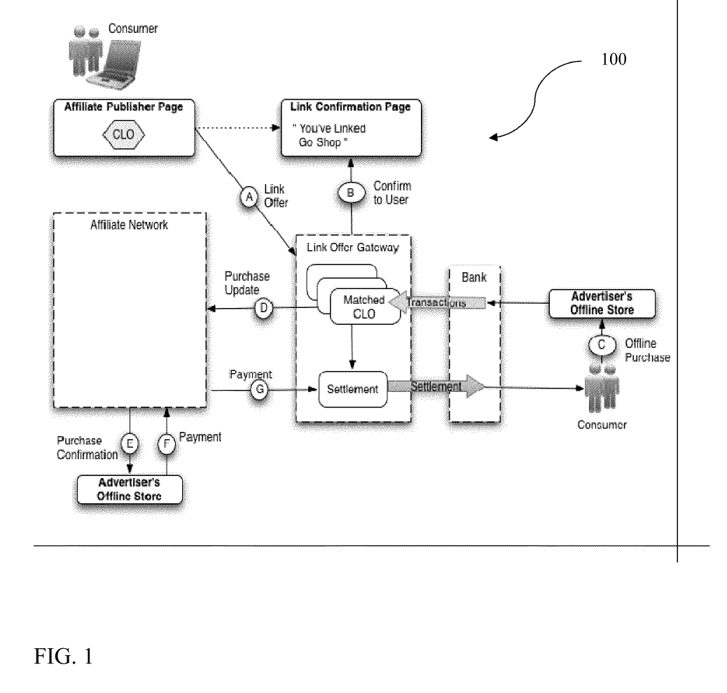

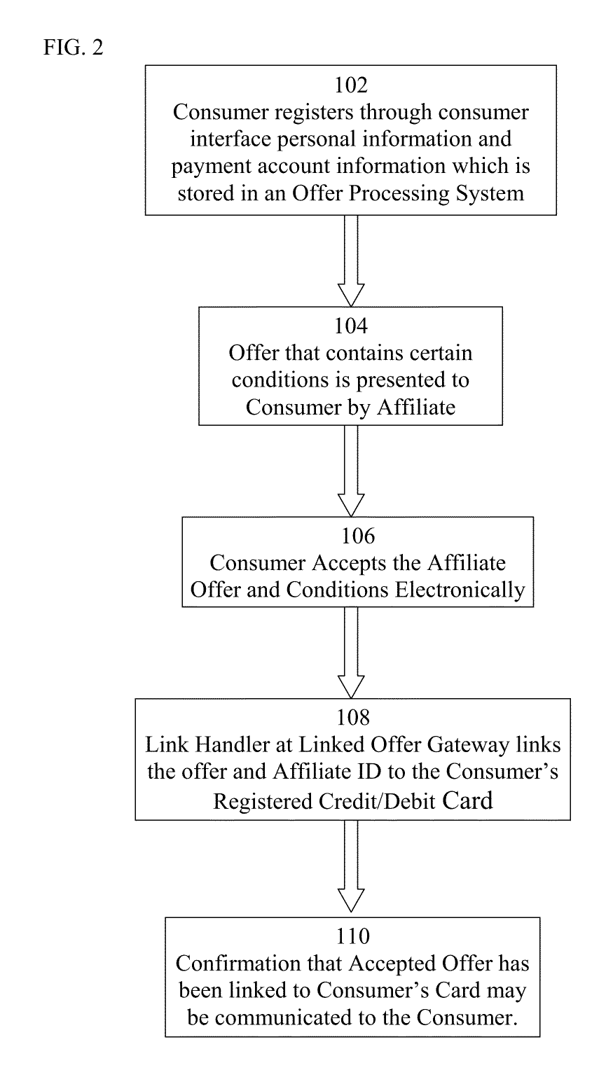

Referring initially to FIGS. 1 and 2, a consumer initially registers through a user interface 102 with the offer processing service 100 described herein by providing certain personal information, such as their name, home address, email information and their payment method information, for example credit/debit or other payment information, along with authorizing offers to be linked to their registered payment method. This information is stored by the offer processing system. The consumer may also choose a user name (or email address) and password to set up an account that will maintain the consumer's information and which the consumer can update, for example by changing their payment method. The account may also be used to track and display offers to the consumer. Offers can be presented to consumers in a variety of ways including, but not limited to, mobile, online and offline advertising, using any available technology.

A merchant who wishes to promote their product, service or the like makes an offer available to an affiliate network that thereafter makes the offers they receive from merchants available to websites or to the affiliates (aka “publishers”). Alternatively the merchant can make their offers available directly to the affiliate. The affiliate, in turn, selects the offers that they wish to promote, and presents them to potential consumers 104. The method of creating an offer, making it available to affiliates who then promote it to consumers is done in any customary manner. For example, an affiliate may present the offer to the consumer using any of a variety of methods, such as through banners, advertisements or links displayed on the affiliate's website, blog, or social media page, or through links located or embedded in an article, review, or the like, and any other manner as provided for by available technology.

After the offer is made available to a consumer by the affiliate, the consumer has the opportunity to activate, or accept the offer electronically. If the consumer has not yet registered with the offer processing service, they are directed to a location where they can register. According to the present disclosure, after a registered consumer accepts the affiliate offer electronically 106, for example by clicking on an online link, the offer is then activated and linked to the consumer's registered payment account. For example, a link handler in the linked offer gateway of the offer processing system 108 may link the affiliate offer to a consumer's registered credit/debit card. The affiliate identifier or ID, which is provided by the affiliate network, is also linked to the offer and payment method by the link handler so that the affiliate can be identified as having provided the offer when redeemed by the consumer in order to receive payment. The linking of the offer including the affiliate id enables redemption of the affiliate offer at offline or “brick and mortar” locations as well as online, and provides a way to track the affiliate that provided the offer which, in turn, allows the affiliate to be compensated.

The offer processing system including the linked offer gateway can comprise a server computer system, which performs the functions described herein. The affiliate network, card issuing banks (or other payment processing entities), consumers, and other users communicate with the offer processing system via a communications network. The network may be any network or combination of networks, including without limitation, the Internet, a local area network, a wide area network, a wireless network and a cellular network. As discussed herein, consumers can accept offers using a client computing device, which may be a laptop, a desktop, a tablet computer, a workstation, a cell phone, a Smartphone, a mobile device, a satellite phone, or any other computing apparatus.

Consumers can accept offers presented to them in any of a variety of ways, for example by using a cell phone to text a response to an offer or by using a smartphone application to bar code scan, quick response (QR) code scan, tag code scan, or **code a mobile response to a display offer, mobile, print, or digital out-of-home (DOOH) advertised offers.

The offer may additionally contain conditions as to how to qualify to redeem the offer, or other conditions that need to be fulfilled. Prior to accepting the offer, conditions of the offer may be communicated to the consumer 104. For example, one condition may be that the offer can be redeemed only at certain locations, for example only at an offline, physical, i.e. brick and mortar location, only during certain days of the week, for certain dollar amounts, only for certain products, or any combination of conditions, such conditions not being limited to those disclosed herein, but any condition or combination of conditions issued by the merchant. The conditions of the offer are typically provided to the consumer at or before the consumer accept the offer. When the consumer fulfills the conditions of the offer, such as purchasing a qualifying product at a qualifying location, the affiliate network is compensated, as described in more detail below.

After the consumer has accepted the affiliate offer and the offer is linked to the consumer's payment method, a confirmation of the linked offer may optionally be sent to the consumer by the linked offer gateway 110, for example, by mobile or other electronic, telecommunication, or computing device through methods such as email, text or through the consumer's registered account. The offer remains linked to the payment method until redeemed by the consumer or removed by the consumer. To redeem the offer, the consumer simply satisfies the conditions of the offer, and makes payment by the linked consumer payment account.

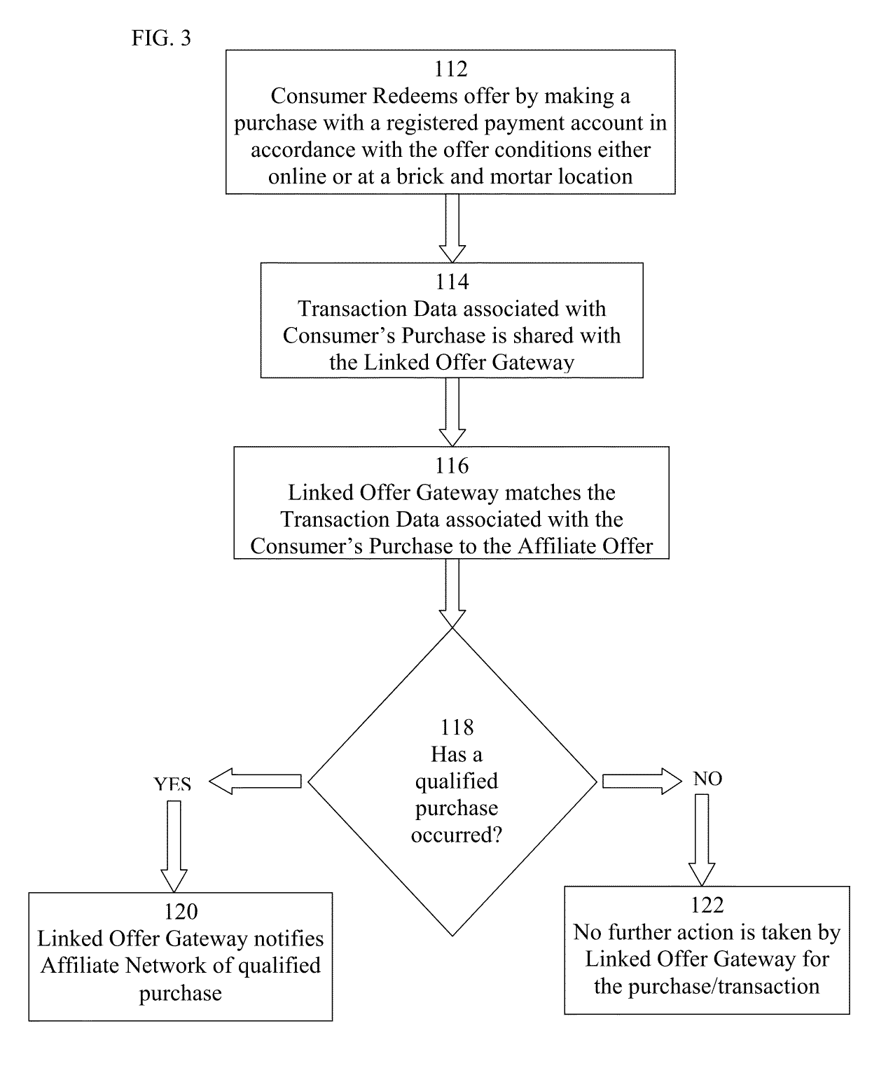

Because the offer is linked to the consumer's payment account, the offer can be redeemed either on-line or at a physical location. Referring now to FIG. 3, the consumer redeems the offer by making a purchase, for example, at an offline, brick and mortar store and pays for the purchase using the registered payment account 112. Once the consumer redeems the offer and makes payment using the linked consumer payment account, the consumer's purchase transaction data travels along the financial lines to the card-issuing bank or other payment issuer and is, in turn, shared with the linked offer gateway 114, typically on a daily basis (which has been authorized by the consumer during the initial payment registration process).

The linked offer gateway checks to confirm that the consumer has met the conditions of the affiliate offer by matching the transaction data associated with the consumer's purchase to the affiliate offer's terms and conditions 116. Verification that the purchase by the consumer has met the conditions of the affiliate offer may be made, for example, by matching specific transaction data, such as whether the product or service was purchased on a certain date or range of dates, from a specified retailer, at or above a specified price, or in combination with other products. In one exemplary embodiment, a unique identifier of a product or service purchased may be matched to a unique identifier specified in the offer to verify that the transaction data meets the affiliate offer criteria by a computer storage system. For example, the unique identifier may include a stock-keeping unit (SKU) code or a radio-frequency identification (RFID) code.

Alternately, the computer storage system may be used to filter out ineligible transactions in the consumer's payment account that do not meet the offer criteria and may thereafter transmit a verification request to an offer issuer or third party data provider using the computer storage system for any transactions remaining in the consumer's payment account. Thereafter, verification of any remaining offer may be accomplished as described above.

If the terms and conditions of the offer have been met, and the purchase is qualified 118, the linked offer gateway sends confirmation to the affiliate network that a qualified purchase has occurred along with the linked, affiliate id associated with the redeemed, qualified offer 120. The linked offer gateway may optionally send a confirmation to the consumer of the qualified redemption, for example, by mobile or other electronic, telecommunication, or computing device through methods such as email, text or through the consumer's registered account. If the purchase is not confirmed to be a qualified purchase, no further action is taken 122.

The affiliate network at any point after receiving notification from the linked offer gateway that a qualified offer has been redeemed can then confirm redemption and notify the merchant and/or the affiliate in its customary manner 124. The merchant then compensates the affiliate network 126 that, in turn, compensates the affiliate whose id was linked with the offer 128, in accordance with the agreed terms as between the merchant, affiliate network and the affiliate, as is customary practice. In the case of a purchase, compensation to the affiliate network is typically expressed as a percentage of the revenue. Compensation may take other forms including, but not limited to, a percentage of revenue associated with the purchase of a specific item or a flat fee, as is customary.

The affiliate network at any point after receiving notification from the linked offer gateway that a qualified offer has been redeemed, transmits payment to the linked offer gateway 130 in accordance with the agreed terms (as between the affiliate network and the linked offer gateway). The linked offer gateway thereafter transmits payment for offer settlement, for example monetary funds, points or the like, back to the consumer's registered payment account 132. In one embodiment, payment for offer settlement may be made to a payment processor which credits the payment to the consumer's payment account. The payment processor may include a bank, a credit or debit card issuer, an online money transfer service, a mobile payment service, an alternative currency issuer, a points or rewards processing system, or a third party settlement provider. Alternatively, the linked offer gateway may also, at its discretion, settle back to the consumer's payment account in advance of receiving payment from the affiliate network. Making payment for The linked offer gateway may optionally send a confirmation to consumer of the settlement payment 134, for example, by mobile or other electronic, telecommunication, or computing device through methods such as email, text or through the consumer's registered account.

As will be appreciated, the system and method described herein by makes redemption of affiliated offers by a consumer a seamless transaction with payment to the consumer payment account being received in an automatic manner, without further intervention required by the consumer regardless of the location of the purchase, either online or at a physical location. In addition, the system and method described herein provides a way to track the affiliate that provided the offer which, in turn, allows the affiliate to be compensated, also regardless of the location of the purchase.

The functions of the offer processing system and other processes described above may be implemented in software, hardware, firmware, or any combination thereof. The processes are preferably implemented in one or more computer programs executing on a programmable computer including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alteration, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the offer processing system may comprise one or more physical machines, or virtual machines running on one or more physical machines. In addition, the offer processing system may comprise a cluster of computers or numerous distributed computers that are connected by the Internet or another network.

In the various exemplary embodiments illustrated herein, the affiliate offers are indicated as being off-line offers, i.e., the offers may be redeemed at brick and mortar locations. This is for purposes of illustration only. It should be understood that the offer processing techniques described herein can, in alternate embodiments, also be applied to offers that can be redeemed by consumers online. Accordingly, the foregoing description and attached drawings are by way of example only, and are not intended to be limiting.

What is claimed is:

1. A computer-implemented affiliate offer redemption method comprising:
(a) receiving information on a consumer and on a consumer's payment account associated with the consumer and storing it in a computer storage system;
(b) receiving activation of an offer from the consumer and storing it in the computer storage system, the offer being made through an affiliate network by an affiliate, the affiliate offer including conditions and an affiliate identifier associated with the affiliate offer;
(c) linking the activated affiliate offer including the affiliate identifier to the consumer's payment account;
(d) monitoring transactions in the consumer's payment account using the computer storage system in order to determine when a qualified purchase has been made by the consumer;
(e) verifying that the purchase is a qualified purchase in accordance with the affiliate offer conditions by using the computer storage system to match transaction data associated with the purchase to the affiliate offer conditions;
(f) upon verifying, notifying the affiliate network of the qualified purchase including the affiliate identifier; and
(g) making a payment for offer settlement to the consumer's payment account using the computer storage system.

2. The method of claim 1, wherein the qualified purchase may be made by the consumer at an offline location, in accordance with the terms of the offer, and wherein the affiliate is compensated regardless of the purchase location provided that a qualified purchase is made.

3. The method of claim 1, further comprising the step of providing confirmation to the consumer that the activated affiliate offer has been linked to the consumer's payment account.

4. The method of claim 1, further comprising the step of providing confirmation to the consumer that payment has been made to the consumer's payment account.

5. The method of claim 1, further comprising the step of requesting payment from the affiliate network.

6. The method of claim 1, wherein the payment account comprises a credit card account, a debit card account, an online money transfer account, a mobile payment account, a virtual money account, or a rewards or points account.

7. The method of claim 1, wherein the payment for offer settlement is made to a payment processor to be credited to the consumer's payment account.

8. The method of claim 7, wherein the payment processor comprises a bank, a credit or debit card issuer, an online money transfer service, a mobile payment service, an alternative currency issuer, a points or rewards processing system, or a third-party settlement provider.

9. The method of claim 1, wherein each of the steps of the method are performed by a server computer system communicating over a communications network with client devices operated by the consumer, payment processors, third party data providers, or offer issuers.

10. A computerized affiliate offer redemption system, comprising;
at least one processor;
memory associated with the at least one processor; and
a program supported in the memory for processing affiliate offers provided to consumers, the program having a plurality of instructions stored thereon which, when executed by the at least one processor, cause the at least one processor to:
(a) store information on a consumer and on a consumer's payment account associated with the consumer;
(b) receive activation of an offer made by an affiliate through an affiliate network from the consumer, the affiliate offer including conditions and an affiliate identifier associated with the affiliate offer;
(c) link the affiliate offer to the consumer's payment account;
(d) monitor transactions in the consumer's payment account;
(e) match transaction data associated with a purchase to the affiliate offer conditions to verify that the purchase is a qualified purchase;
(f) when the transaction is verified as a qualified purchase, transmit a notification to the affiliate network including the affiliate identifier; and
(g) when the transaction is verified as a qualified purchase, make a payment for offer settlement to the consumer's payment account.

11. The system of claim 10, wherein the program further causes the at least one processor to transmit a confirmation to the consumer that the activated affiliate offer has been linked to the consumer's payment account.

12. The system of claim 10, wherein the program further causes the at least one processor to transmit a confirmation to the consumer that payment has been made to the consumer's payment account.

13. The system of claim 10, wherein once the transaction is verified as a qualified purchase, transmit a request for payment to the affiliate network.

14. The system of claim 10, wherein the payment account comprises a credit card account, a debit card account, an online money transfer account, a mobile payment account, a virtual money account, or a rewards or points account.

15. The system of claim 10, wherein the payment for offer settlement is made to a payment processor to be credited to the consumer's payment account.

16. The system of claim 15, wherein the payment processor comprises a bank, a credit or debit card issuer, an online money transfer service, a mobile payment service, an alternative currency issuer, a points or rewards processing system, or a third-party settlement provider.

17. The system of claim 15, wherein to make payment for offer settlement to a payment processor comprises to transfer funds to the payment processor or authorize the payment processor to withdraw funds from a specified account.

18. The system of claim 10, wherein the affiliate offer is available for redemption at either at an on-line location or at an offline location.
